(19) United States
(12) Patent Application Publication
(10) Pub. No.: US 2009/0081623 A1
(43) Pub. Date: Mar. 26, 2009

(54) INSTRUCTIONAL AND COMPUTERIZED SPELLING SYSTEMS, METHODS AND INTERFACES

(76) Inventors: Tracey Dawn Parkinson, Rexburg, ID (US); Robert Garry Parkinson, Rexburg, ID (US)

Correspondence Address: Workman Nydegger;1000 Eagle Gate Tower, 60 East South Temple, Salt Lake City, UT, 84111, US

(21) Appl. No.: 12/237,268

(22) Filed: Sep. 24, 2008

Related U.S. Application Data
(60) Provisional application No. 60/995,294, filed on Sep. 26, 2007.

(51) Int. Cl. G09B 5/00

(52) U.S. Cl. 434/169

(57) ABSTRACT

Methods, systems and interfaces are used in the teaching, practicing, and testing of spelling skills with a computer system. An instructor is provided words, groups of words, and filters for creating word lists to administer to one or more students in a preview. Previews are administered to each of the students for generating individualized word lists that are used to administer practice exercises and practice tests. The individualized word lists can also be used to administer final tests to the students. Some interfaces are used for tracking words passed off by the students as well as words the students fail during the final testing. Graphical user interfaces are provided for instructors and students. Some of the instructor interfaces allow instructors to manage students and student groups and to administer previews, word lists, practice exercises and practice tests, final tests, and reporting.

### CROSS-REFERENCE TO RELATED APPLICATIONS

The present invention claims the benefit of U.S. Provisional Patent Application No. 60/995,294, entitled SPELLING SYSTEMS, METHODS AND INTERFACES, filed Sep. 26, 2007, and which is incorporated herein by reference in its entirety.

### BACKGROUND OF THE INVENTION

1. The Field of the Invention

The present invention generally relates to educational systems, methods and interfaces for teaching, practicing and testing educational skills related to literacy in general, and even more particularly to spelling.

2. Background and Relevant Art

There are many philosophies and systems directed to the development of literacy and spelling. However, as recognized by those involved within the educational industry, no single system or method is recognized as providing a universal answer for effectively teaching literacy skills to all students. Techniques that specifically and successfully target the needs and capabilities of one student often fall short with another. One reason for this is that individual students learn and respond to instructions in different ways. Unfortunately, existing systems fail to provide the flexibility that is necessary to customize instructions for different student needs.

While it is theoretically possible to alter or customize a different lesson plan for each student it can be prohibitively difficult for most educators to perform such a feat in the limited amount of time they have. Initially, it can difficult to know how to customize a lesson for each student and it can be even more difficult to apply and measure the results of the customized lessons.

Another problem in the educational industry is that there are very few online teaching tools that can be used to manage a classroom of students or that a student in a classroom model can use to access and apply learning materials related to spelling.

Despite the foregoing and problems noted with existing systems and the current needs in the educational industry, it will be appreciated that this background is only provided to illustrate exemplary areas where some embodiments of the invention might be practiced. As such, it will also be appreciated that that the subject matter claimed within this application is not limited to any specific embodiments that necessarily solve any of the foregoing disadvantages or that operate only in environments such as those described above.

### BRIEF SUMMARY

Many of the embodiments described in this application are directed towards methods, systems and interfaces that can be used for teaching, practicing and testing spelling and other literacy skills.

Various inventive interfaces are provided for enabling students to access spelling lessons and related learning materials through a computer and to take tests related to their spelling lessons. In some embodiments, a computer runs the interfaces and accesses the learning materials from local stores. In other embodiments, a computer accesses and utilizes the inventive interfaces and materials from one or more remote stores. Applications and interfaces are accessible through any network connection, including, but not limited to the Internet.

According to some embodiments, the learning materials (e.g., lessons and tests) are customized by the instructor prior to being presented to the student. Customization is initially facilitated through the use of interfaces that identify the various lesson plans and materials available for customization. Customization is further facilitated through interfaces that track and reflect student progress and instructional levels. Customizations are applied either individually to the materials for a single student or collectively to a plurality of lessons for one or more students. Customizations are also performed, according to some embodiments, by the students.

According to some learning techniques, an instructor is presented words and customizable listings of word lists from which the instructor can select previews and tests for students to work on. The word lists can be selected by concept as well as other criteria. The instructor can also set requirements for the practices and tests, including time limits, the number of words to test and the ability of the student to further customize the list, such as, but not limited to, by adding additional words.

The student can access the practice and testing materials online. According to some embodiments a preview enables the student to spell a plurality of words from an initial list to find out which words the student knows and which words the student needs to work on. An individualized list of spelling words is generated for each student. The student practices the words they need to work on in a 5-step process that helps to refine and develop their mastery of the words. The student is then tested on their mastery of the words. Students can print off spelling lists to practice while they are away from the computer interfaces as well.

During a preview, practice session, practice test and test, an aural representation of the word (such as a voice recording) is provided through the computer interfaces. The word is also presented in the context of a sentence. The student is then prompted to spell the word. If the student makes an error during a preview, the word is added to a list of words to work on. If the student makes an error during a practice test, the student is prompted to spell the word again. Prompts to spell the word again will be repeated until the word is spelled correctly or until the student misses the word a predetermined number of times.

In some embodiments, spelling the word incorrectly a predetermined number of times causes the correct spelling of the word to be presented to the student, such as in a visual display. In some embodiments, misspelling the word during a test causes the word to be added to the next preview. In some embodiments, a word is counted as being misspelled if the student takes too long spelling the word.

Various other activities can help the student practice the words, including the segmenting activity based on Phonics.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope.

FIG. 1 illustrates an example computing system that may be used to employ embodiments described herein;

FIG. 2 illustrates various literacy teaching components 200 that can be used according to certain methods of the invention for teaching, practicing and testing spelling skills with a computer system;

FIG. 3 illustrates a flowchart of one method for administering a preview;

FIG. 4 illustrates a flowchart of one method for administering a practice test;

FIG. 5 illustrates a flowchart of one method for administering a test;

FIG. 6 illustrates an embodiment of a student graphical user interface for learning, practicing, and testing spelling skills;

FIG. 7 illustrates an embodiment of a test taking graphical user interface for learning, practicing, and testing spelling skills; and

FIG. 8 illustrates an embodiment of an instructor graphical user interface for managing teaching and testing spelling skills.

### DETAILED DESCRIPTION OF THE PREFERRED EMBODIMENTS

Many of the embodiments described in this application are directed towards methods, systems and interfaces that can be used for teaching, practicing and testing literacy skills such as spelling. Accordingly, and as will be understood more filly from the following specification and claims, certain embodiments of the invention enable management and administration of spelling lists to a plurality of students on local and/or distributed computer systems.

According to one embodiment, an instructor assigns word lists to one or more students. The students thereafter generate individualized spelling lists by taking previews of the assigned word lists. Customized spelling lessons are then prepared, based on the preview results, to help each student learn the words in their individualize lists. Students subsequently pass off words in their individualized lists upon showing an adequate mastery of the words, such as, for example, during testing. Embodiments of the invention also enable students and instructors to monitor and modify student progress and to track words the student has passed off.

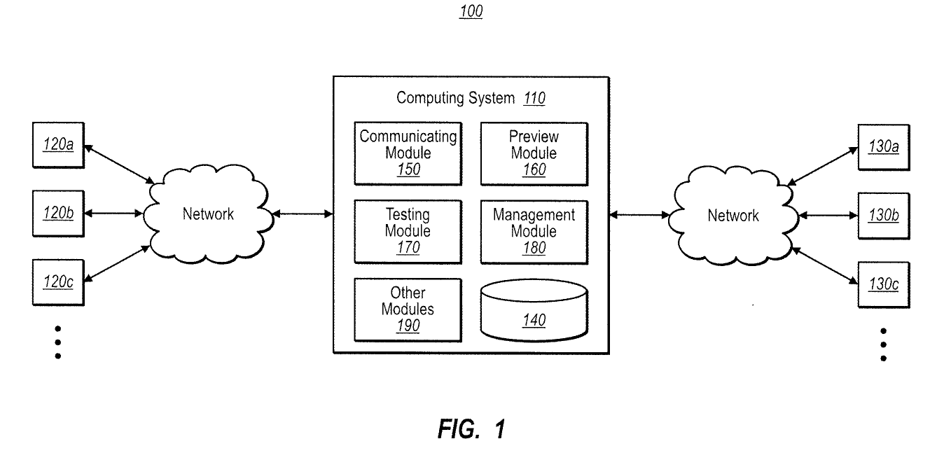

FIG. 1 illustrates one example of a computer network 100 that can be used for practicing certain aspects of the invention. As illustrated the computer network 100 includes a computer system 110 having storage 140 and various computer modules (150, 160, 170, 180 and 190). The computer system 110 is also connected to various other computing systems (120a, 120b, 120c, 130a, 130b, 130c) through one or more wired and/or wireless network connections. Although not shown, the computer systems are also include rendering devices, such as visual displays and audio speakers, for displaying or otherwise rendering interface output, as suggested below. Many of the foregoing network components and system modules will now be described in more detail.

Initially, with regard to the system modules, it will be appreciated that the computing system 110 also includes a processor and other computer hardware that is necessary to execute computer-executable instructions corresponding to the various system modules. It will also be appreciated that the modules can include any combination of computer-executable instructions, written in any appropriate computing language, that are necessary to perform the methods described in this application and to present the corresponding user interfaces reference herein.

Although not necessary, the various computing modules are stored in a storage medium, such as storage media 140. The storage media 140 can include any combination of system memory, RAM, ROM, or portable optical or magnetic storage. While storage media 140 is shown as being incorporated within computing system 110, it will also be appreciated that storage media 140 can also include one or more remotely located stores, such as, for example, stores belonging to the other computing systems (120a, 120b, 120c, 130a, 130b, 130c) or any other remote storage which is accessible through a network connection.

As mentioned above, the various system modules generally include templates, interfaces, and computerized instructions for implementing certain embodiments of the invention. According to one embodiment, the communicating module 150 provides instructions and code for enabling the computing system 110 to communicate with the various other computing systems through one or more network connections. The communicating module also provides interfaces, code and instructions for accessing data from the storage media 140.

The preview module 160 includes interfaces, code and instructions for enabling a preview of words to be created, edited and presented, as described in more detail below. In some embodiments, the result of a preview application is the creation of a word list for studying and testing. The testing module 170 provides corresponding interfaces, code and instructions for creating word lists and for testing student knowledge of the word lists.

Management module 180 includes sufficient interfaces, code and instructions for enabling an administrator or teacher to manage groupings of students and for creating and using customized word listings in teaching and testing applications and interfaces. The management module 180 also includes interfaces, code and instructions for enabling a student to manage their own customized study, testing and mastery materials, including word lists.

Various other modules 190 are also provided with sufficient computerized instructions and code for enabling the various methods, systems and interfaces of the present invention.

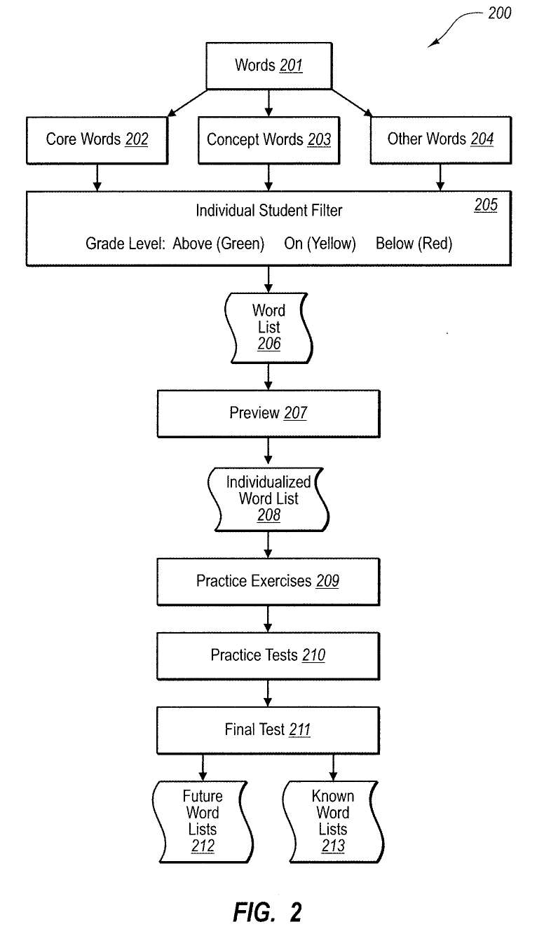

FIG. 2 illustrates various literacy teaching components 200 that can be used according to certain methods of the invention for teaching, practicing and testing spelling skills with a computer system 110. It will be appreciated that the various literacy teaching components 200 are maintained in the storage media 140 of the computing system 110 or any other storage media that is accessible to the computing system 110.

The first few components 201-205 correspond to the initial sets of words that are selected by an instructor such as a parent or teacher and that are used for teaching literacy skills to a student. According to one embodiment, an instructor selects words to assign to an individual student or a group of students as a word list 206.

The words 201 in the word list 206 can be selected from other lists of words that are accessed by the computing system 110 as templates of stored words having a specialized focus, such as a particular phonic, grade level, difficulty, theme or other focus. The words 201 may be provided by the instructor, an educational institution, a third party publishing company, a government entity, or any combination of the above. The words in the word list 206 can include all of the words in a previously prepared listing of words, as well as a modification or limited selection of a previously prepared listing of words. The word list 206 can also include a unique combination of words that is distinguished from any previously created and stored word list that is currently available to the computing system, and such as can be created by having a teacher enter the words of the word list into the computing system through a keyboard or other input device.

According to certain embodiments, the words 201 are ultimately grouped into customized word lists 206 that are assigned to specific students, based on the specific needs of the students. For example, a group of core words 202 can include the words required by a state curriculum, a school curriculum, or any other curriculum. Words can also be grouped into concepts 203, such as grammatically similar words, phonetically similar words, or words with similar letter patterns. Other word groupings 204 can also be provided to accommodate virtually any need or preference of an instructor and can include groupings, such as, but not limited to review words, challenge words, theme words and basic words. The word grouping can be developed and provided by the instructor, by a third party, or by both, at any time and may be shared among various instructors or organizations. A word list can also be modified at any time, by an instructor, by accessing the stored word list and by adding or omitting words on the list.

An instructor can also modify a word list based on a student's current progress or based on any other measurement or metric such as a student's grade level. According to one embodiment, for example, an instructor can filter the words (205) for an individual student by choosing a grade level and words that are above grade level, on grade level, or below grade level. For example, it may be advantageous to provide a grouping of intensive words that are far above grade level to administer to very advanced students. The instructor may designate the groupings with an easily understood visual designation for presentation in a user interface. For example, colors such as green, yellow, and red might designate above grade level, on grade level, and below grade level groupings, respectively.

Although not shown, other filters are also provided within the scope of the present invention. Various interfaces can be used to automatically apply different filters at the instructor's discretion. An instructor can also manually modify or filter a list of words that is presented to the instructor through an interface of the computing system 110.

After an instructor assigns words to an individual student or a group of students to create a selected or customized word list 206, certain embodiments of the invention include the administration of a preview 207 to each corresponding student. A preview 207 is a presentation of learning materials, such as the word list 206, in a specific manner and in such a way as to preliminarily test a student's spelling mastery of words in the word list 206. An instructor assigns a preview 207 to a student to help the student identify the words that the student should spend the most time studying in order to master all the words of the word list. Administration of the preview is also a means for creating a customized or individualized word list for a specific student and which the specific student will later be tested on.

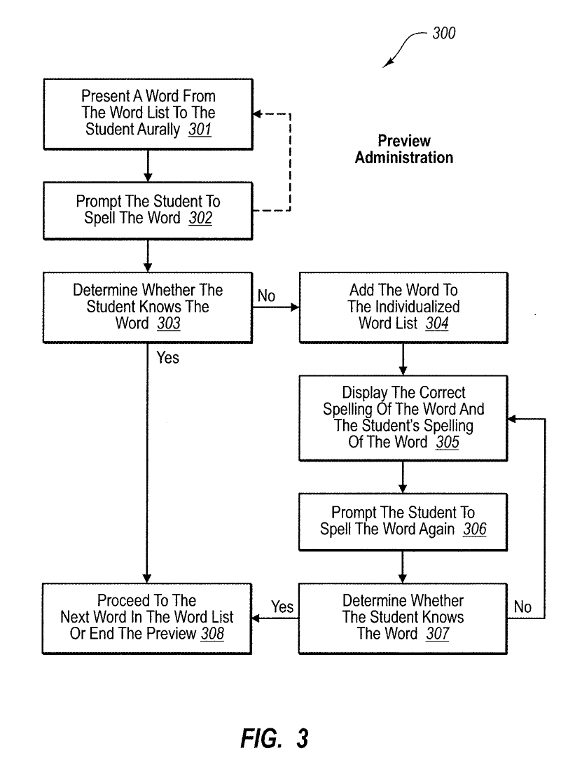

FIG. 3 illustrates one example of a corresponding method 300 for applying a preview to a student and for preliminarily testing the student's knowledge of words in a word list and for creating an individualized word list. In step 301 a computer system presents a word from the word list 206 to the student aurally, such as, for example, through a speaker attached to the computing system 110. The computer system 110 may present the word with recordings of a real voice and/or computer-generated voice. The presentation may take many forms, including the simple pronunciation of the word, as well as the presentation of the word within the context of a sentence.

After the computer system 110 initially presents the word to the student, the student is prompted to spell the word, step 302. Preferably, the computer system 110 prompts the student to spell the word through a computerized interface that is configured to receive input in the form of letters typed on a keyboard or entered on a touch pad. However, it will be appreciated that input can also be received through microphones as well as other input means. For example, the student might type the letters of the word on a keyboard, enter the letters of the word via an on-screen interface, or say the letters of the word aurally into a microphone. Some embodiments may alternatively use sound spelling cards that have a picture or graphical choice representing the sound a letter makes instead of/or in addition to the letters themselves. The sound spelling cards may say a sound associated with a card audibly as the student chooses a card. Other entry methods are also possible, such as touch-sensitive writing pads, scanning mechanisms, or motion-sensing devices.

In some embodiments, the student may be able to request that the computer system present the word again, before or after the student is initially prompted to spell the word. This may be done through various means such as buttons that instruct the computer system to pronounce the word again or to say the sentence again. According to some embodiments, the word will be presented in a same manner or in a different manner each time.

After the student has entered the word, the computing system determines whether the student knows the word (303). This determination (303) can include various analyses, including a determination as to whether the student spelled the word correctly, as well as whether the student spelled the word correctly within an allotted time, and whether a backspace or delete key was ever used. If it is determined that the student knows the word, the student is presented the next word in the word list 206, or, if there are no more words in the word list 206, the preview 207 ends (308).

Alternatively, if it is determined that the student does not know the word (303), the word that the student does not know is added to an individualized word list 208 that is maintained for that particular student (304). The student is then presented with the correct spelling of the word (visually and/or aurally) (305). According to one embodiment, the correctly spelled word is presented along with the student's own spelling of the word. Accordingly to another embodiment, the correctly spelled word is emphasized in such a way as to draw focus to specific letters and/or concepts that are being focused on in the word list. For example, indicators such as alternate colors or highlighting can be used to indicate any concepts being tested, such a specific letter pattern or sound.

After displaying the correct spellings of the word (305), the student is prompted to spell the word again (306). It is then determined, again, whether the student knows the word (307). This determination (307) can use the same criteria as discussed above with regard to step 303, or it may use different criteria. If step 307 determines that the student does not know the word, elements 305-307 are iteratively repeated until it is determined that the student knows the word satisfactorily for the preview. At the very least, this forces the student to spell the word repeatedly until the student enters the correct spelling of the word. In an alternate embodiment, control does not loop back to step 307 when it is determined that the student has misspelled the word a predetermined number of times (1 or more), but instead merely indicates that the student spelled the word incorrectly and proceed to step 308. If the student enters the correct spelling of the word in step 307 then step 308 presents the next word in the word list, or ends the preview when there are no more words in the word list 206.

In some embodiments, the preview 207 may also end if the individualized word list 208 grows too large. For example, the instructor might assign a student a word list 206 containing twenty words, but might also restrict the student's individualized word list 208 to ten words. Accordingly, if the student misses ten words in the preview 207 before finishing all twenty words in the word list 206, the preview 207 might end with the student's individualize word list 208 containing the ten words the student missed.

Upon completion of the preview 207, the student has an individualized word list 207 containing only the words the student had difficulty spelling during the preview test 206. In some cases, such as when the student performed very well during the preview 207, the student's individualized word list 208 might be empty or contain only a small number of words. In such embodiments, the instructor might designate a minimum number of words required for the student's individualized list 208, in which case the instructor or the student might add words to the student's individualized word list 208 manually after the preview 207. For example, the instructor might explicitly add words to the student's individualized word list 208. Alternatively, the instructor might assign a list of words to the student, and then allow the student to select words from the list until the student adds enough words to meet the minimum. In yet another embodiment, the student is able to add words which the instructor did not pre-select, such as words from a dictionary or another source.

After the student has completed the preview 207, and has met any requirements of the individualized word list 208, certain methods of the invention include the administration of practice exercises 209, practice tests 210, and a final test 211.

In one embodiment, the practice exercises 209 comprise five-step word study exercises, or other word study exercises that are presented through computerized interfaces. One five-step word study exercise includes a look, say, and write strategy that guides the student to say the word, to look at each letter of the word individually, to spell the word while the correct spelling of the word is displayed, to spell the word from memory, and to compare the student's spelling of the word from memory with the correct spelling. The computer system may guide the student through the practice exercises 209 only once, or may allow the student to access the exercises multiple times. The computer system may also allow the student to skip the practice exercises 209. The computer system also tracks the student's progress with the practice exercises.

The computer system and corresponding interfaces also guide the student through one or more practice tests 210. In some embodiments the student may only take the practice tests 210 after completing the practice exercises 209. In other embodiments the student may take the practices tests 210 at any time. Further, in other embodiments the student may only take the practice tests 210 once, while in yet other embodiments the student may take the practice tests 210 multiple times. The computer system may also allow the student to skip the practice tests 210 altogether.

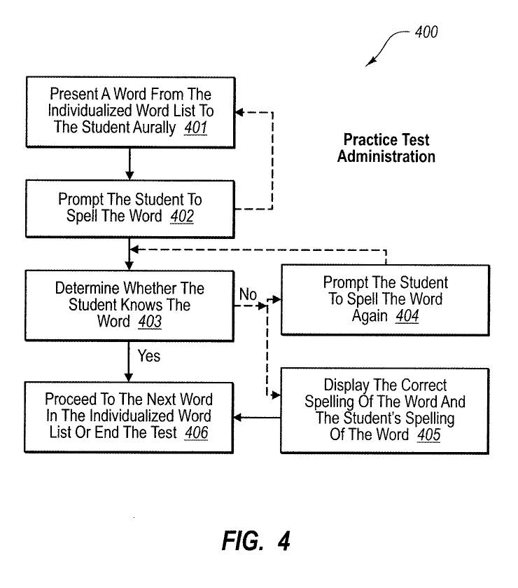

FIG. 4 illustrates one embodiment of a method 400 for administering a practice test 210. A practice test 210 simulates a real test without having any effect on the student's individualized word list 208 or any future word lists 212. During the practice test, the computer system presents words from the individualized word list 208 to the student aurally (401). The aural presentation may take many forms, including pronouncing the word to the student and presenting the word to the student in the context of a sentence. In some embodiments, the computer system presents the word with recordings of a real voice (such as the instructors) instead of using a computer-generated voice, although computer-generated voices can also be used.

After the computer system presents the word to the student, the student is prompted to spell the word (402). In some embodiments, the student can request that the computer system present the word at least one additional time before or after the student is first prompted to spell the word. This may be done through various means such as buttons that instruct the computer system to pronounce the word again or to say the sentence again. After being prompted to spell the word, the student enters the word through various input means. For example, the student might type the letters of the word on a keyboard, enter the letters of the word via an on-screen interface, or say the letters of the word aurally into a microphone. Some embodiments may use sound spelling cards that have a picture or graphical choice representing the sound a letter makes instead of letters themselves. The sound spelling cards may say a sound associated with a card audibly as the student chooses a card. Other entry methods are also possible, such as touch-sensitive writing pads, scanning mechanisms, or motion-sensing devices.

After the student has entered the word, it is determined whether the student knows the word (403). This step may take many forms, including determining whether the student spelled the word correctly and determining whether the student spelled the word correctly within an allotted time. If it is determined that the student knows the word, the student is presented the next word in the individualized word list 208 or, if there are no more words in the individualized word list 208, the practice test 210 ends (406).

If it is determines that the student does not know the word (403), the student is prompted to spell the word again (404). It is then, again, determined whether the student knows the word (403). If the student misses the word repeatedly, control may pass between steps 403 and 404 multiple times until it is determined that the student knows the word or until it is determined that the student has missed the word a predetermined number of times. When it is determined that the student knows the word, the student is presented the next word in the individualized word list 208 or, if there are no more words in the individualized word list 208, the practice test 210 ends (406).

Alternatively, if it is determined that the student does not know the word and that the student has missed the word the predetermined number of times then the student is presented with the correct spelling of the word and the student's own spelling of the word (405). When the correct and incorrect spellings of the word are presented to the student, indicators such as alternate colors or highlighting can be used to focus on the concepts being tested, such a particular letter pattern, a combination of letters or a particular sound. In one embodiment, the predetermined number of times a student is allowed to misspell a word before displaying the correct spelling of the word (405) is two, giving the student only one chance to spell the word correctly after missing it initially. In other embodiments, the predetermined number is one or more than two.

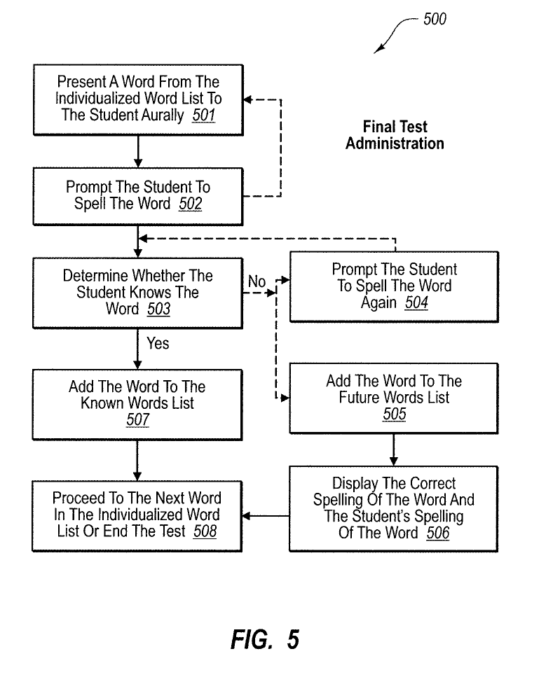

Finally, after completing or skipping the practice exercises 209 and the practice test 210, the method 200 includes a step 211 for administering a final test 211. FIG. 5 illustrates a flowchart 500 of one embodiment for administering a final test 211. As illustrated, the computer system presents a word from the individualized word list 208 to the student aurally (501). The aural presentation may take many forms, consistent with the previous embodiments, including the pronunciation of the word, alone or in the context of a sentence. The word can also be presented with recordings of a real voice (such as the instructors) or a computer-generated voice.

After a word is presented in the final test (501), the student is prompted to spell the word (502). This prompting, as well as the previous promptings for spelling the words during previews and practices, can include a visual prompt (such as text reciting a request to spell the word) or an aural request to spell the word. The initial presentation of the word in a preview, practice or test can also comprise a prompting to spell the word in some embodiments.

The student can preferably, although not necessarily, request that the computer system present the word again before or after the student is prompted to spell the word. This may be done through various means such as buttons that instruct the computer system to pronounce the word again or to say the sentence again. After being prompted to spell the word, the student enters the word through various means. For example, the student might type the letters of the word on a keyboard, enter the letters of the word via an on-screen interface, or say the letters of the word aurally into a microphone. Some embodiments may use sound spelling cards that have a picture or graphical choice representing the sound a letter makes instead of letters themselves. The sound spelling cards may say a sound associated with a card audibly as the student chooses a card. Other entry methods are also possible, such as touch-sensitive writing pads, scanning mechanisms, or motion-sensing devices.

After the student has entered their spelling of the presented word, the computing system determines whether the student knows the word adequately (503). This step may take many forms, including determining whether the student spelled the word correctly and determining whether the student spelled the word correctly within an allotted time. If it is determined that the student knows the word (503), the word is added to a known words list 213 that is maintained for each student (507) and the student is presented with the next word in the individualized word list (508). If there are no more words in the individualized word list 208, the final test 211 ends (508).

Alternatively, if it is determined that the student does not know the word (503), the student is prompted to spell the word again (504), until the word is spelled correctly or until the student has missed the word a predetermined number of times (one or more). The determination as to whether the student knows the word (504) will be based on the input received by the student within predetermined time constraints (as in the other embodiments). If the student spells the word correctly, within the predetermined number of times (one, two, or more), the word is added to the student's known words list 213.

The known words list 213 is a very useful tool for teachers and students to quickly view the words that a particular student has become proficient at. It will be appreciated, however, that the level of knowledge required to prove proficient literacy can vary depending on both the types of students being evaluated as well as the degree of proficiency desired. Accordingly, the present invention also includes methods and interfaces for enabling a teacher or administrator to customize the proficiency requirements for establishing literacy and that are prerequisite to moving a word into the known words list 213. By way of non-limiting example, an instructor can use the teacher interfaces to establish a predetermined number of times a word must be spelled correctly or a minimum number of times the word must be spelled, before being spelled correctly, prior to moving a word to the known word list 213.

Interface options within the teacher and student interfaces also provide access to the known words lists 213 so that instructors and students can readily view the known words lists 213 corresponding to each respective student.

Once a word is spelled correctly, and the word is optionally moved to the known words list 213, the student is then presented with the next word in the individualized word list 208 or, if there are no more words in the individualized word list 208, the final test 211 ends (508).

When it is determined that the student has not spelled the word correctly within a predetermined number of attempts and/or time constraints, the word is added to a future words list 212, rather than the known words list 213 (505). The future word list 212 is a list of words which will be tested in a future preview 207, either alone or in combination with another preview and other new words that the student has not yet been tested on.

The student is also presented with the correct spelling of the word and the student's incorrect spelling of the word when it is determined that the student has not spelled the word correctly within a predetermined number of attempts and/or time constraints (506). Preferably, although not necessarily, the correct and incorrect spellings of the word are displayed with indicators such as alternate colors or highlighting to indicate certain concepts, as described above in related embodiments. Highlighting can also be used in such embodiments to draw attention to the portions of the word that are misspelled.

It will be appreciated that many of the foregoing embodiments utilize computer user interfaces, such as, for example, the interfaces provided by computing system 110. These interfaces include student interfaces, instructor interfaces and administrator interfaces.

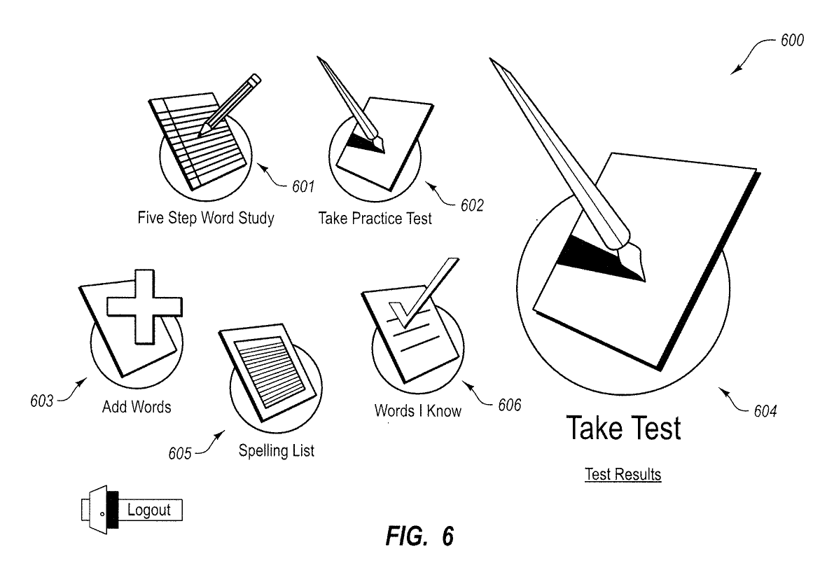

FIG. 6 illustrates one embodiment of a student interface 600 that is presented to a student for managing their spelling lists. In the present embodiment, a student is presented with various selectable options that can be pursued after completing a preview 207. For example, if a student's individualized word list 208 does not contain enough words to meet minimum requirements, the student may need to use the add words 603 option before being able to choose the options 602, 604 to take a practice test 210 or a final test 211. The student interface 600 might also contain one or more selectable options 601 for performing practice exercises 209, such as a five step word study. Additionally, the student interface may contain selectable options 605, 606 to print spelling lists or to list words a student has passed off. This example embodiment only exemplifies one example of a student interface 600 and does not intend to limit possible layouts or the scope of the options and elements available to a student interface 600. It will be appreciated that in some embodiments the student is also presented with a selectable option to take a preview.

Preferably, although not necessarily, the student can access an interface 600, such as the one shown in FIG. 6, upon logging into a secure website managed by an educational administrator or instructor. Each of the selectable options presented in the interface 600 cause the computing system 110 other another computing system (such as system 120a, 120b, or 120c) to display a corresponding interface for engaging in a five step word study (when object 601 is selected), or to take a practice test (when object 602 is selected), or to add words to an individualized list (when object 603 is selected), or to view a spelling list (when object 605 is selected), or to view a known words list (when object 606 is selected), or to take a test (when object 604 is selected), or to take a preview when a preview object is selected (not currently displayed).

Other selectable display objects can also be presented, such as a test results object, which links a student to their test results. Logout objects and other menu objects can also be presented to facilitate the navigation through the corresponding various webpages.

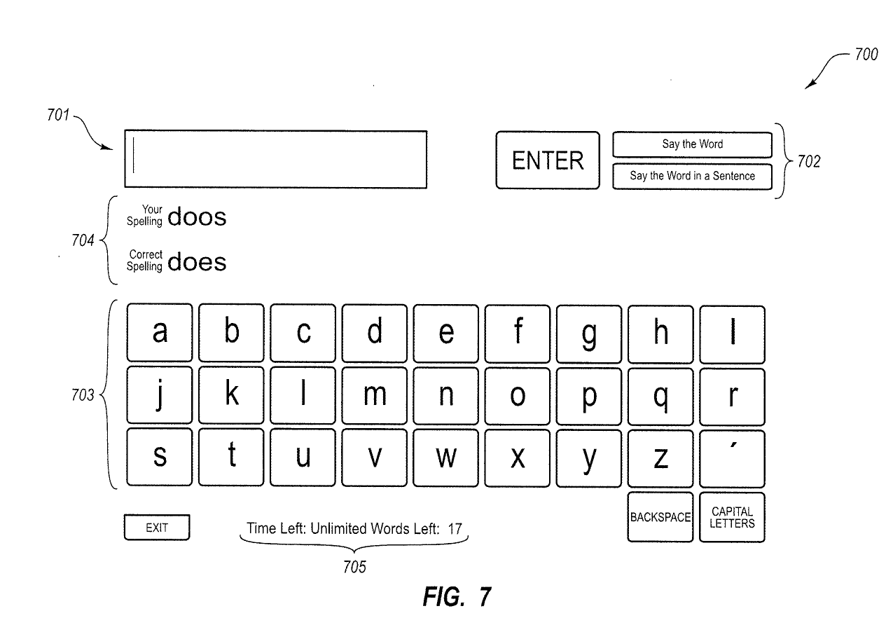

FIG. 7 illustrates one embodiment of an interface 700 having various components corresponding to the preview and test interfaces of the invention 700. Similar interfaces are used for the presentation of previews 207, practice tests 210, and final tests 211. Correspondingly similar interfaces are also well-suited for the presentation of practice exercises 209.

Interface 700 includes a field 701 to input letters of a word and a corresponding enter button to select after the word is fully entered and which will cause the preview, practice or test to advance to the next word or process. Other selectable buttons 702 are also presented to direct the computer to restate audibly a word or a sentence.

Interface 700 also includes a plurality of other display elements including a keyboard interface to allow a student to input letters 703 through the selection of a mouse or touch screen; a status indicator 705 to display remaining words in a list, as well as a time remaining to answer a question (a time is not presently shown). Interface 700 also includes a location 704 for displaying the correct spelling of a word and the student's spelling of a word, when appropriate.

With specific regard to the interface 700 shown in FIG. 7, it will be appreciated that different display elements can be selectively presented within the different preview, practice and testing interfaces, as desired, to accommodate different needs and preferences and such that it is not required that all of the display elements be presented in any one of the interfaces. It will also be appreciated that different layouts and element presentations can also be used to achieve a desired look and feel.

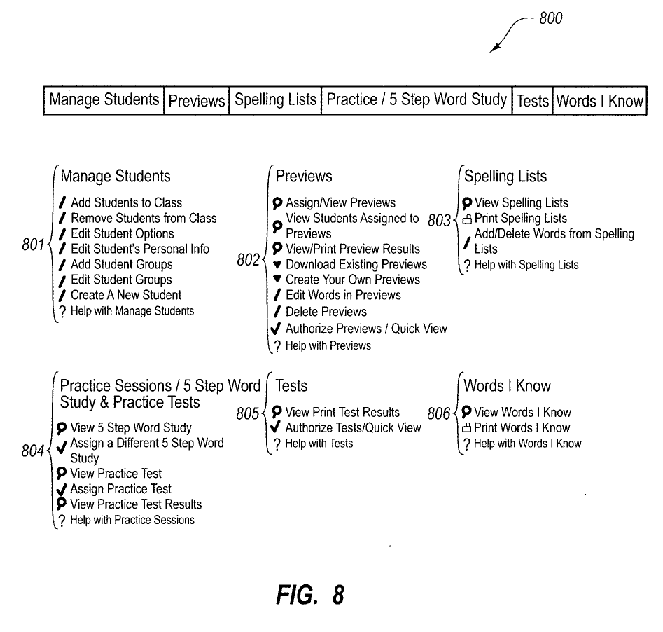

FIG. 8 illustrates another interface 800 that can be utilized according to the present invention. This interface 800 is specifically configured for an instructor such as a teacher to manage student groupings, student progress, previews, spelling lists, practice sessions, tests and other word lists. A teacher or other instructor preferably accesses this interface 800 through one or more computing systems (such as 130a, 130b, 130c, of FIG. 1) that are connected to a centralized server (such as computing system 110) and which has access to all of the stored interfaces and corresponding data.

Access to the teacher interface 800 is preferably limited to instructors or other individuals having authorized credentials which are verifiable by the computing system in response to receiving a login name and password of an authorized instructor.

According to one embodiment, each of the displayed elements in interface 800 is a selectable link to one or more corresponding webpages or interfaces. For example, various selectable links are presented within a first section 801 for managing a plurality of students. Each of the listed components in section 801 are selectable links to other webpages or interfaces for managing students, such as, but not limited to adding and removing students, managing student groups, and editing student options and information, and so forth. For instance, the ‘edit student options’ object links to an interface for setting a maximum and minimum number words required in a student's individualized list 208 before being able to take a test, a time limit in which the student must correctly answer each question, and a core list of words the student must learn. Other options for managing students are accessible through the other displayed links.

Teacher interface 800 also includes other selectable options for managing various aspects of the described embodiments for teaching, practicing and testing spelling skills using a computer system. For example, interface 800 includes a section 802 with selectable links for managing previews 802. This section 802 includes various links to interfaces that allow an instructor to view, remove, create, and manage word lists 206 to be administered as previews 207, and may include options for sharing preview word lists 206 with other instructors. This section 802 also includes links to interfaces for assigning word lists 206 to one or more students and view word lists 206 currently assigned to each student. Additionally, section 802 also includes links to interfaces that allow an instructor to view results of administered previews 207 and to modify the availability of previews 207 and change options related to the previews 207.

Interface 800 also includes a section 803 for managing spelling lists. This section 803 includes various links to interfaces for viewing and printing spelling lists and for modifying spelling lists.

Interface 800 also includes a section 804 of links to interfaces for managing practice exercises 209 and practice tests 210, including interfaces for assigning specific practice exercises 209 and practice tests 210 to a student or to a group of students. Section 804 also includes links to interfaces through which the instructor can view the results of practice exercises 209 and practice tests 210 of specific student(s).

Interface 800 also includes a section 805 with links to interfaces for managing final tests 211. For example, section 805 includes links to interfaces for viewing the results of final tests 211 and for authorizing a student to take a final test 211 even if that student has not met all qualifications for taking the final test 211.

Interface 800 also includes a section 806 related to known words, with links to corresponding interfaces for viewing words which a particular student or groups of students has passed off and for printing off the known words.

Other interfaces are also provided, although not presently shown, such as administrator interfaces which provide selectable options for enabling an administrator to set up instructor accounts and for enabling management of the teacher interfaces and other interfaces that have been described above. For example, the administrator interfaces provide options for an administrator to augment and/or modify the teacher interfaces and student interfaces to include additional or fewer interface options and for modifying the layout and general look and feel of the teacher and student interfaces.

The administrator interfaces also provide selectable options and menus for setting security and authorization level requirements for limiting or otherwise controlling access to the various interfaces described above. For example, the administrator interfaces provide options for setting login requirements, such as password and user name requirements, as well as other verification requirements, such as teaching certification data or other requirements.

According to one embodiment, a different administrator interface will be provided for each of a plurality of different geographic or non-geographic regions. In one embodiment, an administrator interface is associated with a particular geographic region defined by a school district. In other embodiments, administrator interfaces are more locally restricted and are associated with a particular school. Some administrator interfaces are also associated with non-geographical groupings, such as educational grades, clubs and other associations.

Although many of foregoing examples and interfaces have been discussed in detail, one skilled in the art will recognize that teacher interface 800 can also be modified to include additional options and layouts to accommodate different needs and preferences. Accordingly, the present invention may be embodied in other specific forms without departing from its spirit or essential characteristics. In view of the foregoing, the described embodiments are to be considered in all respects only as illustrative and not restrictive.

We claim:

1. A computer-implemented method for presenting a preview word list to one or more students in a preview to determine which of the words in the preview word list each of the one or more students knows how to spell and for generating one or more customized word lists to be presented to each of the one or more students, respectively, as a test, the method comprising the acts of:
identifying one or more students;
identifying a preview word list to be presented to the one or more students as a preview, wherein the preview word list is customizable;
assigning the preview word list to the one or more students as a preview to determine which of the words in the preview word list each of the one or more students knows how to spell and for generating one or more customized word lists to be presented as a test to each of the one or more students, respectively, and based on results of the preview by each of the one or more students; and
administering the preview word list as a preview to each of the one or more students and generating a customized word list for each student, wherein administering the preview and generating the customized word list for each student comprises the acts of:
presenting the word to each student aurally;
prompting each student to spell the word;
determining whether each student knows the word by determining whether each student spelled the word correctly within an allotted time; and
adding a particular word to the customized word list associated with each corresponding student that is determined to have failed to spell the particular word within the allotted time.

2. The method recited in claim 1, wherein the method further includes presenting the customized word list to at least one of the one or more students as a test.

3. The method of claim 1, wherein the act of identifying the preview word list comprises an act of choosing one or more words from one or more categories comprising: core words, word concepts, school curriculum, basic words, review words, challenge words, below-grade level words, and above-grade level words.

4. The method of claim 1, wherein the act of presenting the word to each student aurally comprises the acts of:
pronouncing the word; and
aurally presenting the word in the context of a sentence.

5. The method of claim 4, further comprising using recordings from a real voice rather than a computer generated voice.

6. The method of claim 1, wherein the act of generating the customized word list for each student further comprises an act of displaying the correct spelling of the particular word when it is determined that the particular word has been misspelled or when it is determined that the particular word was not spelled correctly within the allotted time, and wherein the act of displaying the correct spelling of the particular word further comprises highlighting only some of the letters in the particular word.

7. The method of claim 6, further comprising prompting a student to spell the particular word repeatedly until said student successfully enters the correct spelling of the word in the allotted time.

8. The method of claim 1, further comprising an act of allowing a student to add additional words to the customized word list after completing the preview.

9. A computer-implemented method for administering a computerized spelling test to a student based on a customized word list, the method comprising the acts of:
identifying a customized word list that has been customized to a particular student and which is based on application of a first preview to said student;
presenting teaching materials to the student through a computerized interface corresponding to the customized word list;
administering a practice test of the customized word list to the student, wherein the administration of the practice test includes:
presenting each word from the customized word list to the student aurally and prompting the student to spell the word;
determining whether the student has spelled the word correctly;
iteratively prompting the student to spell the word again, until and unless it is determined that the student has spelled the word correctly within an allotted time or until the student has misspelled the word a predetermined number of times; and
providing computerized instructions for presenting the correct spelling of the word to the student in circumstances in which it is determined that the student misspells the word the predetermined number of times; and
administering a final test of the customized word list to the student, wherein the administration of the final test includes:
presenting each word from the customized word list to the student aurally and prompting the student to spell the word;
iteratively prompting the student to spell the word again, until and unless it is determined the student has spelled the word correctly within the second allotted time or until the student misses the word a second predetermined number of times;
wherein if the student spells the word correctly within the second allotted time before missing the word the second predetermined number of times the word is removed from the customized word list; and
wherein if the student misspells the word the second predetermined number of times the correct spelling of the word is displayed to the student and the word is put in a new customized word list such that the word will be administered in a future preview with at least one additional new word that was not presented in the first preview.

10. The method of claim 9, wherein for each word in the word list, the teaching materials comprises guiding the student through the steps of saying the word, looking at each letter of the word individually, spelling the word with the correct spelling of the word displayed, spelling the word from memory, and comparing the student's spelling of the word from memory with the correct spelling.

11. The method of claim 9, further comprising an act of allowing the student to add other words to the customized word list before administering the test.

12. The method of claim 9, wherein the practice test and the test are only administered if there are a minimum number of words in the customized word list.

13. The method of claim 9, wherein the teaching materials and the practice test are administered a plurality of times.

14. The method of claim 9, wherein the act of presenting the word to the student aurally comprises the acts of:
pronouncing the word; and
aurally presenting the word in the context of a sentence.

15. The method of claim 9, wherein the act of removing a word from the customized word list further comprises an act of adding the word to a known words list which keeps track of all words which the student has learned in a plurality of previews and tests.

16. A graphical user interface which is displayed at a computer system, the graphical user interface comprising:
a first display element which comprises a selectable display object which, when selected by a user, causes the graphical user interface to display options for managing a plurality of students;
a second display element which comprises a selectable display object which, when selected by a user, causes the graphical user interface to display options for managing preview exams and lists;
a third display element which comprises a selectable display object which, when selected by a user, causes the graphical user interface to display options for viewing, printing, and managing word lists associated with each student;
a fourth display element which comprises a selectable display object which, when selected by a user, causes the graphical user interface to display options for managing practice exams and practice sessions for each student;
a fifth display element which comprises a selectable display object which, when selected by a user, causes the graphical user interface to display options for viewing results of tests as well as for authorizing tests; and
a sixth display element which comprises a selectable display object which, when selected by a user, causes the graphical user interface to display options for viewing words learned by each of the plurality of students.

17. The graphical user interface of claim 16, wherein the options for managing a plurality of students comprise:
adding students, creating and managing student groups, and editing student options and information.

18. The graphical user interface of claim 17, wherein the student options comprise:
a maximum number words the student can be tested on in each test;
a time limit in which the student must correctly answer each question;
a core list of words the student must learn; and
a requirement that there be a minimum number of words which the student is to be tested on before the student is able to take a test.

19. The graphical user interface of claim 16, wherein the options for managing preview exams and lists further comprises options for:
assigning preview word lists to students;
viewing the preview word lists currently assigned to each student;
adding, removing, and modifying the preview word lists;
viewing results of administered previews; and
modifying the availability of previews and change options related to the previews.

20. The graphical user interface of claim 16, wherein the interface is controlled by modules stored on a server remotely located from the computing system that is displaying the interface.
